(19) United States
(12) Patent Application Publication
(10) Pub. No.: US 2010/0061322 A1
(43) Pub. Date: Mar. 11, 2010

(54) METHOD FOR ALLOCATING CODE TO CELLS AND PLANNING CELLS IN OFDM CELLULAR SYSTEM

(75) Inventors: Il-Gyu Kim, Seoul (KR); Hyeong-Geun Park, Daejeon (KR); Young-Jo Ko, Daejeon (KR); Kapseok Chang, Daejeon (KR); Hyoseok Yi, Daejeon (KR); Young-Hoon Kim, Daejeon (KR); Seung-Chan Bang, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/516,032

(22) PCT Filed: Nov. 23, 2007
(86) PCT No.: PCT/KR2007/005961

§ 371 Date: May 22, 2009

(30) Foreign Application Priority Data
Nov. 23, 2006 (KR) 10-2006-0116116
Nov. 23, 2007 (KR) 10-2007-0120077

(51) Int. Cl. H04W 4/00

(52) U.S. Cl. 370/329

(57) ABSTRACT

A piece of user equipment (UE), which has received more than two synchronization codes at the same time, has a problem in that the UE may not confirm the synchronization codes due to an increase in inter-signal interference. As a result, the UE may not acquire a primary scrambling code (PSC). A method of transmitting a forward synchronization signal in a wireless communication system includes: each base station existing in a wireless communication system generating a frame according to a predetermined unit of frame timing by using a same external clock signal; and allocating different offsets to frames of adjacent base stations by using the external clock signal so that forward link common channels included in the frames do not overlap each other, and transmitting the frames. In addition, a method of allocating a cell code suitable for an OFDM cellular system, a forward link frame transmitting method, a method of setting timing between cells, and a method of setting timing between a base station and a mobile station can be derived.

### TECHNICAL FIELD

The present invention relates to a method of setting frame timing or allocating a code between cells or base stations in an orthogonal frequency division multiplexing (OFDM) cellular system, and a mobile station apparatus using the method.

### BACKGROUND ART

In a conventional orthogonal frequency division multiplexing (OFDM) communication system, a transmitter, i.e., a base station, transmits pilot sub-carrier (pilot channel) signals to receivers, i.e., terminals. The base station simultaneously transmits the pilot channel signals and data sub-carrier (data channel) signals to the terminals. The pilot channel signals are transmitted so as to perform synchronization acquisition, channel estimation, and base station identification.

The OFDM method recently used for high-speed data transmission in a wired/wireless channel is a method of transmitting data using multi-carriers and is a type of multi carrier modulation (MCM) method of parallel converting a serially input symbol stream, modulating each parallel data to a plurality of sub-carriers, i.e., sub-channels, having inter-orthogonality, and transmitting the plurality of sub-channels.

A system using such an MCM method was applied to military high frequency (HF) radio for the first time in the late 1950s, and the OFDM method in which a plurality of orthogonal sub-carriers are repeatedly used was developed from the 1970s.

However, the OFDM method has a limitation in terms of its application to systems due to the difficulty in implementation of orthogonal modulation between multi-carriers.

However, since Weinstein et al. disclosed in 1971 that modulation and demodulation using the OFDM method can be efficiently processed by using discrete Fourier transformation (DFT), technological development of the OFDM method has been rapid.

In addition, since the use of a guard interval and a cyclic prefix guard interval insertion method were disclosed, system problems in multi-paths and delay spread have been solved.

Accordingly, the OFDM method is widely applied to digital transmission technologies, such as digital audio broadcasting (DAB), digital television, wireless local area networks (WLANs), and wireless asynchronous transfer mode (WATM) systems.

That is, the OFDM method, despite the complexity of hardware, has been widely used according to the development of various digital signal processing technologies including fast Fourier transformation (FFT) technology and inverse FFT (IFFT) technology.

The OFDM method is similar to a conventional frequency division multiplexing (FDM) method but has a characteristic in that optimal transmission efficiency can be obtained in high-speed data transmission by maintaining orthogonality between a plurality of sub-carriers in the data transmission and having good frequency use efficiency and robustness in multi-path fading.

In addition, since frequency spectra are repeatedly used in the OFDM method, the use of frequencies is efficient, and the OFDM method is advantageous in terms of robustness in frequency selective fading and multi-path fading. Furthermore, by using the OFDM method, inter symbol interference (ISI) can be reduced by using a guard interval and an equalizer structure in hardware can be simply designed, and the OFDM method is robust in regard to impulse noise, and thus, the OFDM method is widely used in communication system structures.

In a wideband code division multiple access (WCDMA) method of the 3^{rd} generation partnership project (3GPP), the beginning of a frame is determined by a node-B frame number counter (BFN) generated by a base station (node-B) and a cell system frame number counter (SFN) determined by a time offset (T_cell) considering a service area (cell) served by the node-B.

The BFN is system clock information of every base station, wherein a specific number of BFN is maintained for a predetermined time and if a predetermined period elapses, a counter of the BFN increases by 1 and a period corresponding to the increased BFN starts.

When a single base station controls a plurality of cells, the T_cell value is one of 0 to 9. Thus, each channel transmits an information frame after a T_cell time from a BFN start time. Accordingly, the beginning of a synchronization channel (SCH) is determined at a time delayed by the T_cell time from the BFN start time.

A user equipment (UE) device secures a primary scrambling code (PSC) for identifying a base station (Node-B) based on an information frame obtained from the SCH.

512 pseudo-random noise (PN) codes classified by 64 groups are used to identify base stations in a WCDMA system. Each group includes 8 PN codes. PN codes are classified into several groups in an asynchronous method as described in order to quickly provide initial synchronization, for finding out a type and a start point of a PN code, to a UE. An SCH includes a primary SCH (P-SCH) and a secondary SCH

(S-SCH), and a mobile terminal achieves synchronization by acquiring slot synchronization through the P-SCH and acquiring frame synchronization and a base station PN code through the S-SCH.

Thus, the UE confirms the best signal from the P-SCH, sets synchronization by a corresponding slot, and confirms the S-SCH. That is, the UE confirms a slot start point through the P-SCH. The S-SCH performs transmission by using a different code for every slot.

Thus, the UE confirms a PN code group of a base station to which the UE belongs from a set of orthogonal codes allocated to every slot. Thus, the UE, which has detected the PN code group to which the UE belongs through the S-SCH, confirms a PN code of the base station to which the UE belongs by searching for the PN code in the PN code group.

Based on this, a method in which a WCDMA system sets synchronization using external time information (global positioning system (GPS)) to obtain an advantage in terms of handover between base stations is suggested since accurate synchronization when performing a handover between base stations is important.

However, in a WCDMA system using the GPS, a start time of a BFN is the same for every cell based on a reference time received from the GPS, and accordingly, there is a problem in that a start time of an SFN and a start time of a slot are limited by T_cell. In addition, the number of cells influencing a specific UE is generally more than 10 in a second layer.

Thus, the specific UE can receive more than 2 synchronization codes from adjacent cells at the same time.

Thus, A UE receiving more than 2 synchronization codes from adjacent cells at the same time may not detect the synchronization codes due to an increase in interference between signals. As a result, the UE may not be able to acquire a PSC.

### DETAILED DESCRIPTION OF THE INVENTION

### Technical Problem

A method of allocating a cell code in an orthogonal frequency division multiplexing (OFDM) cellular system, a forward link frame transmitting method, a method of setting timing between cells, and a method of setting timing between mobile stations are suggested.

### Technical Solution

According to an aspect of the present invention, there is provided a method of transmitting a forward synchronization signal in a wireless communication system, the method comprising: each base station existing in a wireless communication system generating a frame according to a predetermined unit of frame timing by using a same external clock signal; and allocating different offsets to frames of adjacent base stations by using the external clock signal so that forward link common channels included in the frames do not overlap each other, and transmitting the frames.

According to another aspect of the present invention, there is provided a cell search method using a forward synchronization signal in a wireless communication system, the method comprising: acquiring an offset boundary of a frame included in the forward synchronization signal by using a primary synchronization channel (P-SCH), a secondary synchronization channel (S-SCH), and a common pilot channel existing in the frame; and acquiring a frame timing boundary by considering offset information of the frame and a propagation delay according to a distance from a base station, which has transmitted the frame, by using a primary broadcast channel (P-BCH) existing in the frame.

Base stations 101, 102, and 103 according to an embodiment of the present invention have sectors 110, 111, 112, 120, 121, and 122, where each sector is defined as a cell in the present invention.

In a base station system of the present invention, each base station receives a time from an external clock signal providing device, such as the global positioning system (GPS), uses the received time to generate global frame timings 110 and 111, each of which has a unit of 10 msec, and allocates a different offset 130 from the global frame timing to forward link common channels, such as a P-SCH, an S-SCH, a P-BCH, and a common pilot channel, so that the forward link common channels transmitted from the adjacent base stations 101, 102, and 103 do not overlap each other, thereby allowing a mobile station to efficiently search a cell.

In a method according to an embodiment of the present invention, one or more sector cells belonging to a single base station has the same offset, and a synchronization channel signal transmitted to each sector cell of the base station is always transmitted to the same part in the time domain and the frequency domain.

In this case, the transmitted P-SCH and S-SCH are the same signal transmitted to sectors in the base station so that the sectors operate as a type of single frequency network in the base station, or different P-SCH and S-SCH are transmitted to sectors in the base station.

In a method according to an embodiment of the present invention, besides the synchronization channels, a timing reference of a P-BCH for informing a mobile station of fundamental system information, such as system band information, antenna information, time information (frame count), etc., and a common pilot signal of a base station used to estimate a data channel, are also based on the offset frame boundary 121 of the base station. Meanwhile, a multimedia broadcast and multimedia service (MBMS) data channel, a unicast shared data channel, and a unicast shared control channel of a forward link are based on the global frame timings 110 and 111.

A base station carries a sub-frame offset value 130 unique to the base station on a P-BCH or another forward link control channel and transmits the P-BCH or other forward link control channel to a mobile station, and the mobile station, which has acquired the offset frame boundary 121 of the base station in a cell search step, acquires the global timing boundary 111 by demodulating the P-BCH or other forward link control channel in which the sub-frame offset information is included and by acquiring the sub-frame offset information, and receives an MBMS data service or a unicast data service.

In addition, a timing reference of an uplink used for transmission of a mobile station is also based on the global frame timing boundary 111.

### Advantageous Effects

According to the present invention, a cell code allocating method suitable for an orthogonal frequency division multiplexing (OFDM) cellular system, a forward link frame transmitting method, a method of setting timing between cells, and a method of setting timing between a base station and a mobile station are provided.

In addition, in a wideband code division multiple access (WCDMA) system using the global positioning system (GPS), confusion in regard to synchronization codes between cells or base stations can be minimized by setting different transmission timings of the synchronization codes for each cell or base station.

In addition, by setting different synchronization code transmission timings for every cell by allocation of BFN start points changed by allocating an offset to each of the BFN start points, an advantage of using GPS during a handover can be maintained.

In addition, a user terminal can acquire a primary scrambling code (PSC) of each base station and effectively perform a cell search process.

### DESCRIPTION OF THE DRAWINGS

The above and other features and advantages of the present invention will become more apparent by describing in detail exemplary embodiments thereof with reference to the attached drawings in which:

FIG. 1 illustrates a cellular system having three-sector base stations according to an embodiment of the present invention;

FIG. 2 illustrates a forward link frame structure according to an embodiment of the present invention;

FIG. 3 illustrates a relationship between global frame timings and a base station (Node B) frame timing for transmitting forward common channels, according to an embodiment of the present invention;

FIG. 4 illustrates a pattern of synchronous channels (SCHs) allocated to a plurality of sector cells belonging to a single base station;

FIG. 5 is a timing diagram illustrating communication between a base station and a mobile station according to an embodiment of the present invention;

FIG. 6 is a flowchart illustrating a forward synchronization signal transmitting method according to an embodiment of the present invention; and

FIG. 7 is a flowchart illustrating a cell search method using a forward synchronization signal according to an embodiment of the present invention.

### BEST MODE

According to an aspect of the present invention, there is provided a method of transmitting a forward synchronization signal in a wireless communication system, the method comprising: each base station existing in a wireless communication system generating a frame according to a predetermined unit of frame timing by using a same external clock signal; and allocating different offsets to frames of adjacent base stations by using the external clock signal so that forward link common channels included in the frames do not overlap each other, and transmitting the frames.

The frame may be divided into a plurality of sub-frames, each of the sub-frames may comprise a data channel symbol and a pilot channel symbol, and some of the plurality of sub-frames may comprise a synchronization channel.

Each of the forward link common channels may comprise primary and secondary synchronization channels (P-SCH and S-SCH) specifying each base station, a primary broadcast channel (P-BCH) containing a bandwidth, the number of antennas, and a frame count of the wireless communication system, and a common pilot channel containing information for channel estimation of a data channel contained in the frame.

Each of the base stations may have one or more sector cells, and frames containing the same P-SCH and the same S-SCH between sectors in the base station may be transmitted.

Each of the base stations may have one or more sector cells, and frames containing a different P-SCH and a different S-SCH between sectors in the base station may be transmitted.

Each of the base stations may have one or more sector cells, and frames containing the same P-SCH and a different S-SCH between sectors in the base station may be transmitted.

When there is no possibility for each base station in the wireless communication system to transmit a forward signal to the same mobile station, the frames may be transmitted by allocating a same offset to the frames.

The minimum unit of the offset may be equal to a length of a plurality of sub-frames into which the frame is divided.

According to another aspect of the present invention, there is provided a cell search method using a forward synchronization signal in a wireless communication system, the method comprising: acquiring an offset boundary of a frame included in the forward synchronization signal by using a primary synchronization channel (P-SCH), a secondary synchronization channel (S-SCH), and a common pilot channel existing in the frame; and acquiring a frame timing boundary by considering offset information of the frame and a propagation delay according to a distance from a base station, which has transmitted the frame, by using a primary broadcast channel (P-BCH) existing in the frame.

When a cell adjacent to a cell that is already searched for handover is searched, offset information and a frame timing boundary of a frame, which the adjacent cell transmits, may be acquired by using offset information of the already searched cell.

### MODE OF THE INVENTION

Hereinafter, exemplary embodiments of the present invention will be described in detail with reference to the attached drawings.

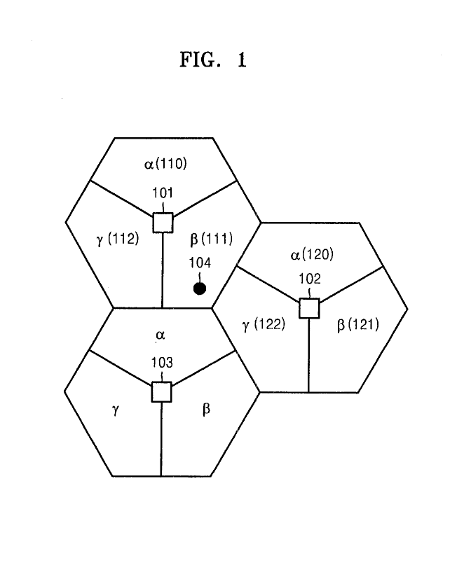

FIG. 1 illustrates a cellular system having three-sector base stations according to an embodiment of the present invention.

A mobile station 104 must acquire timing and a cell identification (ID) of a cell having the highest magnitude when power is initially turned on or handover is performed. At present, in a 3^{rd} generation partnership project (3GPP) long term evolution (LTE) system, a unicast service and a multimedia broadcast and multimedia service (MBMS) service are simultaneously considered.

In the case of cells providing the MBMS service, each base station must operate in a base station synchronization mode.

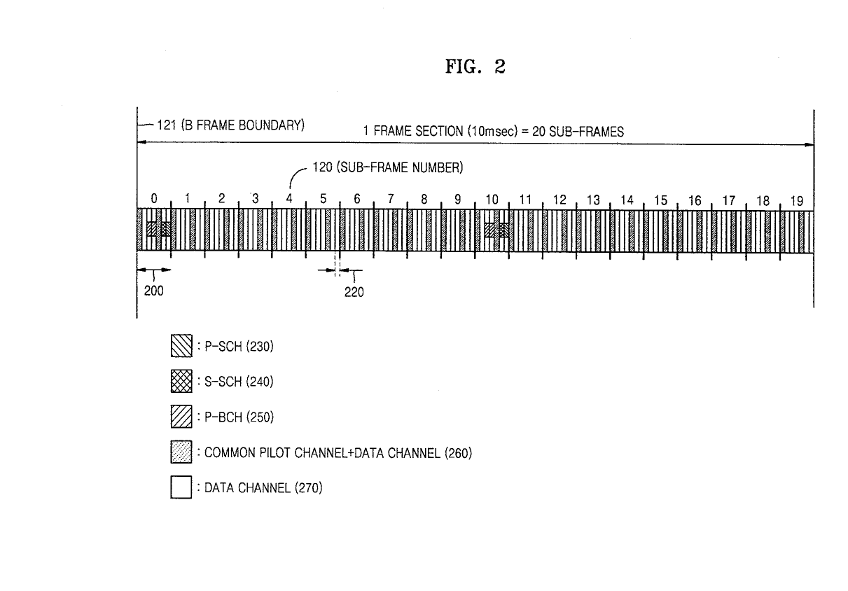

FIG. 2 illustrates a forward link frame structure according to an embodiment of the present invention.

Basically, a 10-msec frame is divided into 20 sub-frames, each sub-frame including data channel symbols 260 and 270 and a pilot channel symbol 260. Meanwhile, the number of sub-frames including 2 synchronization channels is 2.

A pilot channel is multiplied by a scrambling code unique to each of base stations 101, 102, and 103, and sectors in each base station can be identified by multiplying each multiplication result by an orthogonal code. The sub-frame is the minimum unit for allocating data thereto and a time length of the sub-frame is 0.5 msec in the 3GPP.

In the 3GPP, when base stations operate in a synchronization mode, it is assumed that a reference 10-msec frame boundary of all channels transmitted from all base stations is the same. In this case, there is a problem in that P-SCHs and S-SCHs transmitted from the adjacent base stations 101, 102, and 103 may always be received by a mobile station at the same time.

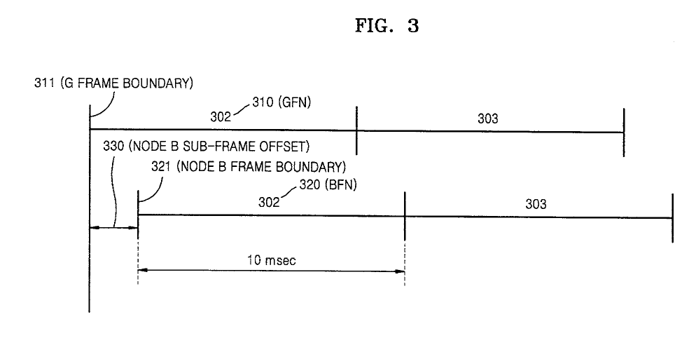

FIG. 3 illustrates a relationship between global frame timings 310 and 311 and base station (Node B) frame timings 320 and 321 for transmitting forward common channels, according to an embodiment of the present invention.

In a base station system according to the current embodiment, each base station basically receives a time from an external clock signal providing device, such as the global positioning system (GPS), generates global frame timings 310 and 311, each frame timing having a unit of 10 msec, by using the received time, and allocates a different offset 330 from the global frame timing to at least one of forward link common channels, such as a P-SCH, an S-SCH, a P-BCH, and a common pilot channel, so that the forward link common channels transmitted from the adjacent base stations 101, 102, and 103 do not overlap each other, thereby allowing a mobile station to efficiently perform a cell search.

The minimum unit of the offset is preferably a single sub-frame (0.5 msec), and since a period of a synchronization channel is 5 msec, a total of offsets of 10 sub-frames exist in the example of FIG. 2. That is, since the total number of offsets is limited, cells must be arranged so that base stations located far from each other use the same offset.

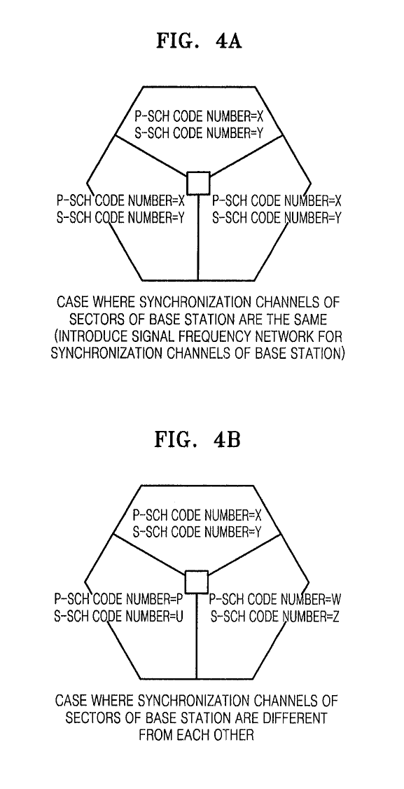

FIG. 4 illustrates a pattern of synchronous channels (SCHs) allocated to a plurality of sector cells belonging to a single base station.

In a method according to the present invention, one or more sector cells belonging to a single base station have the same offset, and a P-SCH, an S-SCH, a P-BCH, and a common pilot channel transmitted to each sector cell of the base station are always transmitted to the same part in the time domain and the frequency domain. In this case, the transmitted P-SCH and S-SCH are the same signal (code) transmitted to sectors in the base station so that the sectors operate as a type of single frequency network in the base station (FIG. 4A), different P-SCHs and different S-SCHs are transmitted to the sectors in the base station (FIG. 4B), or the same P-SCH and different S-SCHs are transmitted to the sectors in the base station (FIG. 4C).

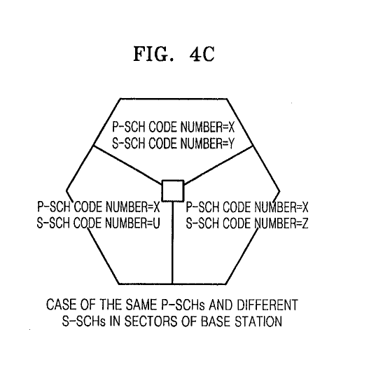

FIG. 5 is a timing diagram illustrating communication between a base station and a mobile station according to an embodiment of the present invention.

In a method according to the present invention, besides the synchronization channels, a transmission timing reference of a P-BCH for informing the mobile station of fundamental system information, such as system bandwidth information, antenna information, time information (frame count), etc., and a common pilot signal of the base station used for channel estimation of a data channel in a cell search third step, are also based on an offset frame boundary 321 of the base station.

Meanwhile, a transmission timing reference of multimedia service (MBMS) data channel, a unicast shared data channel, and a unicast shared control channel of a forward link are based on global frame timings 310 and 311.

The base station carries a sub-frame offset value unique to the base station on the P-BCH or another forward link control channel and transmits the P-BCH or other forward link control channel to a mobile station, and the mobile station, which has acquired an offset frame boundary 521 including a propagation delay 540 from the base station to the mobile station using a P-SCH, an S-SCH, and a common pilot channel in a cell search step, acquires a global timing boundary 511 including the propagation delay 540 by demodulating the P-BCH or other forward link control channel in which the sub-frame offset information is included and by acquiring the sub-frame offset information and demodulates a data channel containing an MBMS data service or a unicast data service based on the global timing boundary 511.

In addition, a timing reference of an uplink used for transmission of the mobile station is based on the global frame timing boundary 511 including the propagation delay 540.

Meanwhile, the mobile station must continuously search for adjacent base stations for handover besides performing an initial cell search, and in this case, the mobile station receives information on the adjacent base stations from a cell (home cell or serving cell) with which the mobile station currently sets a call, and a base station inserts the sub-frame offset information 330 into the information on the adjacent base stations.

Thus, the mobile station can reduce an operation amount of a cell search unit by using the sub-frame offset information 330 in a cell search of an adjacent base station.

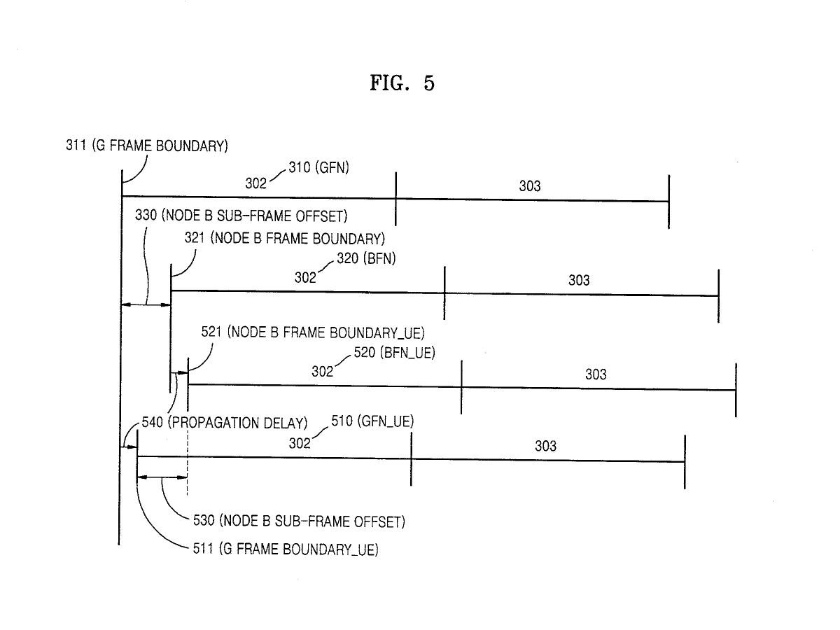

FIG. 6 is a flowchart illustrating a forward synchronization signal transmitting method according to an embodiment of the present invention.

Each base station existing in a wireless communication system, according to the present embodiment of the present invention, generates a frame according to a predetermined unit of frame timing by using a same external clock signal, in operation S600.

The base stations allocate different offsets to frames of respective adjacent base stations by using the external clock signal so that forward link common channels included in the frames do not overlap each other, and transmit the frames, in operation S610.

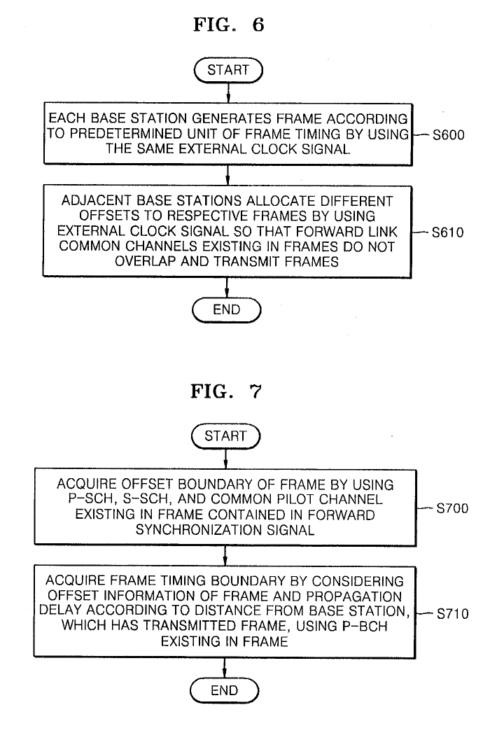

FIG. 7 is a flowchart illustrating a cell search method using a forward synchronization signal according to an embodiment of the present invention.

An offset boundary of a frame included in the forward synchronization signal is acquired by using a P-SCH, an S-SCH, and a common pilot channel existing in the frame, in operation S700.

A frame timing boundary is acquired by considering offset information of the frame and a propagation delay according to a distance from a base station, which has transmitted the frame, and by using a P-BCH existing in the frame.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A method of transmitting a forward synchronization signal in a wireless communication system, the method comprising:
each base station existing in a wireless communication system generating a frame according to a predetermined unit of frame timing by using a same external clock signal; and
allocating different offsets to frames of adjacent base stations by using the external clock signal so that forward link common channels included in the frames do not overlap each other, and transmitting the frames.

2. The method of claim 1, wherein the frame is divided into a plurality of sub-frames,
each of the sub-frames comprises a data channel symbol and a pilot channel symbol, and
some of the plurality of sub-frames comprise a synchronization channel.

3. The method of claim 1, wherein each of the forward link common channels comprises primary and secondary synchronization channels (P-SCH and S-SCH) specifying each base station, a primary broadcast channel (P-BCH) containing a bandwidth, the number of antennas, and a frame count of the wireless communication system, and a common pilot channel containing information for channel estimation of a data channel contained in the frame.

4. The method of claim 3, wherein each of the base stations has one or more sector cells, and frames containing the same P-SCH and the same S-SCH between sectors in the base station are transmitted.

5. The method of claim 3, wherein each of the base stations has one or more sector cells, and frames containing a different P-SCH and a different S-SCH between sectors in the base station are transmitted.

6. The method of claim 3, wherein each of the base stations has one or more sector cells, and frames containing the same P-SCH and a different S-SCH between sectors in the base station are transmitted.

7. The method of claim 1, wherein when there is no possibility for each base station in the wireless communication system to transmit a forward signal to the same mobile station, the frames are transmitted by allocating a same offset to the frames.

8. The method of claim 1, wherein the minimum unit of the offset is equal to a length of each of a plurality of sub-frames into which the frame is divided.

9. A cell search method using a forward synchronization signal in a wireless communication system, the method comprising:
acquiring an offset boundary of a frame included in the forward synchronization signal by using a primary synchronization channel (P-SCH), a secondary synchronization channel (S-SCH), and a common pilot channel existing in the frame; and
acquiring a frame timing boundary by considering offset information of the frame and a propagation delay according to a distance from a base station, which has transmitted the frame, by using a primary broadcast channel (P-BCH) existing in the frame.

10. The method of claim 9, wherein when a cell adjacent to a cell that is already searched for handover is searched, offset information and a frame timing boundary of a frame, which the adjacent cell transmits, are acquired by using offset information of the already searched cell.
